(19) United States
(12) Patent Application Publication
(10) Pub. No.: US 2018/0035387 A1
(43) Pub. Date: Feb. 1, 2018

(54) FRAME STRUCTURE DESIGN FOR OFDMA BASED POWER CONTROL IN 802.11AX STANDARDS AND SYSTEM

(71) Applicant: INTEL IP CORPORATION, SANTA CLARA, CA (US)

(72) Inventors: Rongzhen YANG, Shanghai (CN); Peng MENG, Shanghai (CN); Po-Kai HUANG, Santa Clara, CA (US); Qinghua LI, San Ramon, CA (US); Hujun YIN, Saratoga, CA (US); Robert STACEY, Portland, OR (US); Xiaogang CHEN, Beijing (CN)

(21) Appl. No.: 15/549,348

(22) PCT Filed: Mar. 27, 2015
(86) PCT No.: PCT/CN2015/075186

§ 371 Date: Aug. 7, 2017

(51) Int. Cl. H04W 52/24; H04B 7/0426; H04W 72/08; H04W 52/14

(52) U.S. Cl. CPC H04W 52/241; H04W 52/143; H04B 7/0426; H04W 72/085; H04W 72/0473

(57) ABSTRACT

A method is provided by the present invention, comprises determining communication channel quality from a first wireless communications device to one or more other wireless communications devices, and assigning a zone/subband and corresponding power level to the one or more other wireless communications devices based on the communication channel quality. The method is directed toward at least addressing the interference from neighboring Access Points (APs), and reducing interference between devices using different power zones/subbands when the wide-band of Orthogonal Frequency-Division Multiple Access (OFDMA) based technologies were adopted in Wi-Fi systems for unlicensed bands.

### TECHNICAL FIELD

An exemplary aspect is directed toward communications systems. More specifically an exemplary aspect is directed toward wireless communications systems and even more specifically to power control in wireless communications systems.

### BACKGROUND

Wireless networks are ubiquitous and are commonplace indoors and becoming more frequently installed outdoors. Wireless networks transmit and receive information utilizing varying techniques. For example, but not by way of limitation, two common and widely adopted techniques used for communication are those that adhere to the Institute for Electronic and Electrical Engineers (IEEE) 802.11 standards such as the IEEE 802.11n standard and the IEEE 802.11ac standard.

The IEEE 802.11 standards specify a common Medium Access Control (MAC) Layer which provides a variety of functions that support the operation of 802.11-based wireless LANs (WLANs). The MAC Layer manages and maintains communications between 802.11 stations (such as between radio network cards (NIC) in a PC or other wireless devise(s) or stations (STA) and access points (APs)) by coordinating access to a shared radio channel and utilizing protocols that enhance communications over a wireless medium.

IEEE 802.11ax is the successor to 802.11ac and is proposed to increase the efficiency of WLAN networks, especially in high density areas like public hotspots and other dense traffic areas. IEEE 802.11ax will also use orthogonal frequency-division multiple access (OFDMA). Related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of un-balanced interference on different frequency subbands;

FIG. 2 illustrates another example of un-balanced interference on different frequency subbands;

FIG. 3 illustrates an exemplary base station (BSS);

FIG. 4 illustrates a first exemplary transmission power control scheme;

FIG. 5 illustrates a second exemplary transmission power control scheme;

FIG. 6 illustrates a third exemplary transmission power control scheme;

FIG. 7 illustrates a fourth exemplary transmission power control scheme;

FIG. 8 illustrates a resulting interference mitigation using techniques disclosed herein;

FIG. 9 illustrates an exemplary large scale deployment having different power configurations;

FIG. 10 is a flowchart illustrating an exemplary method for utilizing different power zones/subbands;

FIG. 11 is a flowchart outlining an exemplary method for utilizing different power zones/subbands; and

FIG. 12 is a flowchart outlining an exemplary method for utilizing different power zones/subbands.

### DESCRIPTION OF EMBODIMENTS

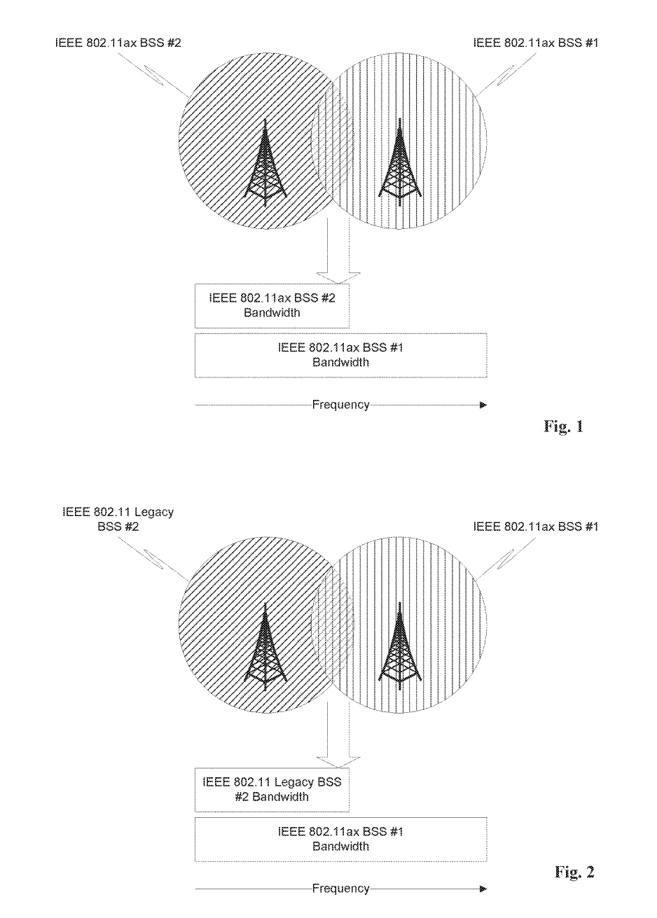

When the wide-band of OFDMA (Orthogonal Frequency-Division Multiple Access) based technologies were adopted in Wi-Fi systems for unlicensed bands, one specific problem occurs in overlapping basic service set (OBSS) environments. Specifically, the different frequency subbands can suffer different levels of interference from neighbouring access points (APs) as shown in FIGS. 1 and 2.

In FIGS. 1 and 2, two different examples of un-balanced interference on different frequency subbands are illustrated. In FIG. 1, there are two similar IEEE 802.11ax base stations (BSS), or access point (APs), but the two different APs use different bandwidths for deployment. In this example, the APs will interfere with each other on the shared subbands, which are overlapped as shown in FIG. 1.

In FIG. 2, a second example is provided where one BSS or access point is an IEEE 802.11 legacy access point, and the second access point or BSS is IEEE 80211.ax. Here, the two different BSSs use different bandwidth, but as can be seen in FIG. 2, still experience interference on the overlapped or shared subbands.

One exemplary embodiment is directed toward at least addressing the above interference problems.

One exemplary embodiment takes advantage of OFDMA based multiuser access and provides additional opportunities for performance optimization by applying different transmission power levels in different OFDMA zones (or frequency subbands). This technique can at least address interference problems and cell coordination issues.

Discussed herein are several exemplary versions of an IEEE 802.11ax frame structure that can support the different transmission power levels in an OFDMA environment. These differing transmission power levels can greatly improve the overall wireless LAN (WLAN) system performance by reducing interference. Moreover, one additional benefit is that some of the exemplary techniques discussed herein can be implemented with limited additional complexity.

The performance of Wi-Fi devices in OBSS environments can be greatly degraded to nearly zero in conditions with strong interference from neighbouring BSSs. Through using different transmission power control levels on different OFDMA zones (or subbands) in, for example, IEEE 802.11ax or mixed environments, exemplary technique are directed toward solving at least this problem through interference mitigation.

Since the different transmission power levels are applied on different OFDMA zones (or subbands), the IEEE 802.11ax AP's can easily schedule devices with different conditions on different OFDMA zones (or subbands), respectively. The OFDMA resource for device in a low power zone (or subband) can be assigned to IEEE 802.11ax devices that are determined to be within a “good” range, e.g., at a closer distance, and the OFDMA devices or resources in a high power zone (or subband) can be assigned to the IEEE 802.11ax devices that are in “poor” conditions, such as at a cell edge, at a distance from the AP, or other situation/environment in which connectivity is poor. This allows enhancement of device performance for those devices that are, for example, at a cell edge.

The assessment as to whether a device is in “good” or “poor” connectivity range relative to the AP can be determined, for example, based on one or more known techniques, such as SNR (Signal to Noise Ratio), statistics of Packet Error Rate (PER), channel quality index (CQI), or in general any one or more channel quality measurement(s).

In accordance with the one exemplary embodiment, the technique is controlled in the frequency domain. For example, after an access point optionally reserves a channel using full power, the subsequent data packets over different zones/subbands are sent using different power levels to, for example, minimizing the co-channel interference.

In accordance with one exemplary embodiment, if an AP chooses to use zero power on certain frequency zones/subbands, then the AP simply does not transmit packets on those zones/subbands. Therefore, the proposed power control techniques as discussed herein can be applied more generally than simply allocating bandwidths to nearby devices in a mutually exclusive set(s) of operating frequency bands.

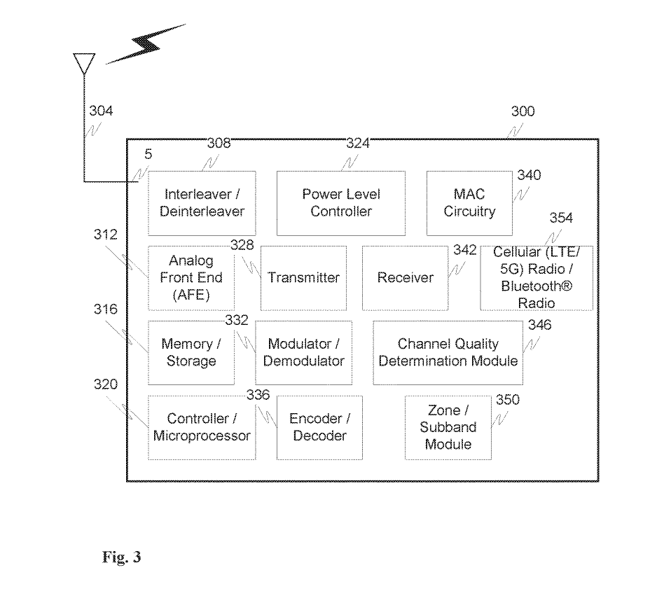

FIG. 3 illustrates an exemplary transceiver or wireless device, such as that found in an access point or BBS or station or device that is adapted to implement the technique(s) discussed herein.

In addition to well-known componentry (which has been omitted for clarity), the transceiver 300 includes one or more antennas 304, an interleaver/deinterleaver 308, an analog front end (AFE) 312, memory/storage 316, controller/microprocessor 320, transmitter 328, modulator/demodulator 332, encoder/decoder 336, MAC Circuitry 340, receiver 342, and optionally one or more radios such as the cellular radio/Bluetooth®/Bluetooth® low energy radio 354. The various elements in the transceiver 300 are connected by one or more links (not shown, again for sake of clarity).

The wireless device 300 can have one more antennas 304, for use in wireless communications such as multi-input multi-output (MIMO) communications, Bluetooth®, etc. The antennas 304 can include, but are not limited to directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 304 generally interact with an Analog Front End (AFE) 312, which is needed to enable the correct processing of the received modulated signal. The AFE 312 can be located between the antenna and a digital baseband system in order to convert the analog signal into a digital signal for processing.

The wireless device 300 can also include a controller/microprocessor 320 and a memory/storage 316. The wireless device 300 can interact with the memory/storage 316 which may store information and operations necessary for configuring and transmitting or receiving the information described herein. The memory/storage 316 may also be used in connection with the execution of application programming or instructions by the controller/microprocessor 320, and for temporary or long term storage of program instructions and/or data. As examples, the memory/storage 320 may comprise a computer-readable device, RAM, ROM, DRAM, SDRAM and/or other storage device(s) and media.

The controller/microprocessor 320 may comprise a general purpose programmable processor or controller for executing application programming or instructions related to the wireless device 300. Further, controller/microprocessor 320 can perform operations for configuring and transmitting information as described herein. The controller/microprocessor 320 may include multiple processor cores, and/or implement multiple virtual processors. Optionally, the controller/microprocessor 320 may include multiple physical processors. By way of example, the controller/microprocessor 320 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The wireless device 300 can further include a transmitter 328 and receiver 342 which can transmit and receive signals, respectively, to and from other wireless devices or access points using the one or more antennas 304. Included in the wireless device 300 circuitry is the medium access control or MAC Circuitry 340. MAC circuitry 340 provides for controlling access to the wireless medium. In an exemplary embodiment, the MAC circuitry 340 may be arranged to contend for a wireless medium and configure frames or packets for communicating over the wireless medium.

The wireless device 300 can also optionally contain a security module (not shown). This security module can contain information regarding but not limited to, security parameters required to connect the wireless device to an access point or other device or other available network(s), and can include WEP or WPA security access keys, network keys, etc. The WEP security access key is a security password used by Wi-Fi networks. Knowledge of this code will enable a wireless device to exchange information with the access point. The information exchange can occur through encoded messages with the WEP access code often being chosen by the network administrator. WPA is an added security standard that is also used in conjunction with network connectivity with stronger encryption than WEP.

As shown in FIG. 3, the wireless device 300 also includes a power level controller 324, a channel quality determination module 346 and a zone/subband module 350. One or more of these elements cooperate with one or more of the other elements in the wireless device 300 to implement the exemplary frame structures as discussed hereinafter that allow for transmission power control, and thus interference mitigation.

In operation, and at a high level, the channel quality determination module 346 makes an initial assessment as to what the quality of the channel is between the wireless device 300 and another wireless device. As discussed herein, and based, for example, on one or more thresholds, measurements, estimates, information in a table, or other criteria, the wireless device 300 makes a determination as to which zone a device it is communicating with should be assigned. Then, in cooperation with the zone/subband module 350, the power level controller 324, and one or more other components of the wireless device 300, one or more transmission power control schemes as discussed hereinafter are assigned and utilized to, for example, communicate while mitigating interference.

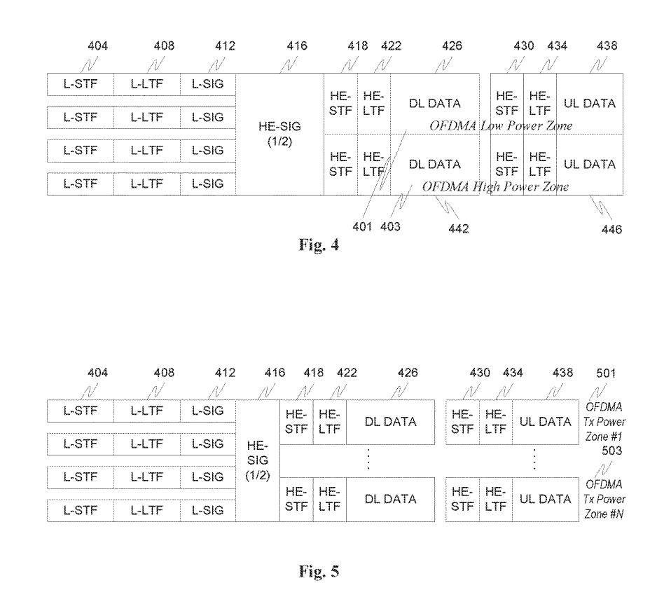

In particular, FIGS. 4-7 illustrate exemplary transmission power control schemes that can be used by the wireless device 300.

In general, and as illustrated in the Figures, L-STF is the non-HT short training field and L-LTF is the non-HT long training field. These fields are identical to the fields used in IEEE 802.11a, and they include a sequence of 12 OFDM symbols that are used to assist the receiver in identifying that an IEEE 802.11 frame is about to start, synchronizing timers, and selecting an antenna. Any IEEE 802.11 device that is capable of OFDM operation can decode these fields.

The L-SIG field is a non-HT signal field that is used by IEEE 802.11a to describe the data rate and length (in bytes) of the frame, which is used by receivers to determine the time duration of the frame's transmission. IEEE 802.11ac devices set the data rate to 6 MBps and derive a spoofed length in bytes so that when any receiver calculates its length, it matches the time duration required for the 802.11ac frame.

The data fields (both the DL (download) data and UL (uplink) data) hold the higher-layer protocol packet, or optionally an aggregate frame containing multiple higher-layer packets. This field is described as a data field and, in the situation where no data field is present in the physical layer payload, it can be referred to as a no data packet (NDP). The SIG field may be a high efficiency SIG (HE-SIG) field as defined by the IEEE 802.11 high efficiency WLAN or HEW study groups. As discussed, the HE-SIG fields may be one or two parts designated as HE-SIG1 and HE-SIG2, respectively. HE-STF is the high efficiency short training field, again defined in accordance with IEEE 802.11, and the HE-LTF being the high efficiency LTF being usable to, for example, distinguish between an IEEE 802.11a and an IEEE 802.11g packet as defined by IEEE 802.11ax. Details regarding the status of IEEE802.11 high efficiency wireless LAN can be found at, for example, ieee802.org/11/reports/hew_update.htm.

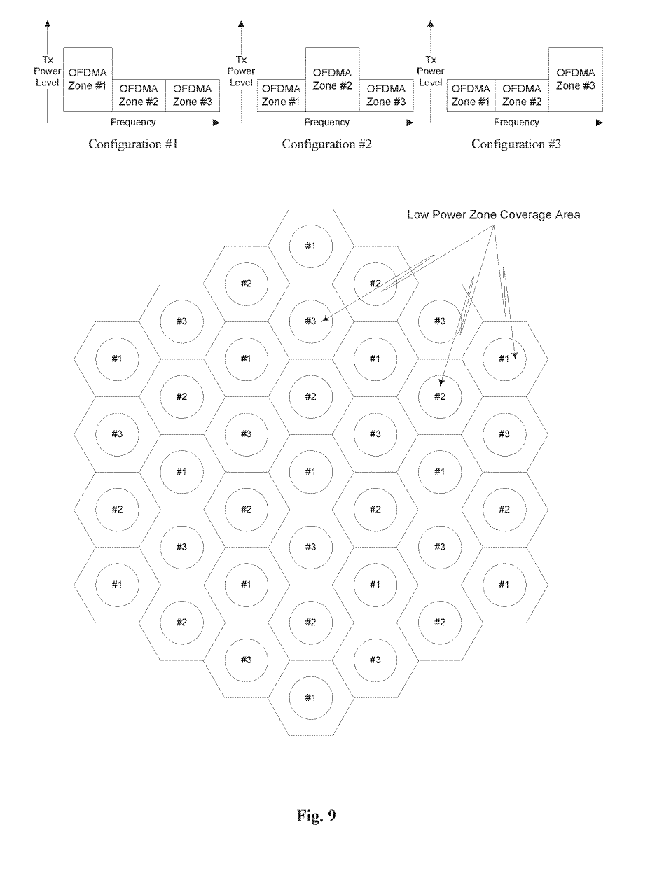

In FIG. 4, a data-only transmission power control scheme is shown, which utilizes two different OFDMA zones, an OFDMA low power zone 401 and an OFDMA high power zone 403. As shown in FIG. 4, the exemplary scheme is a data-only transmission power control that is applied on the two OFDMA zones 401 and 403. In this exemplary data-only transmission power control scheme, L-STF 404, L-LTF 408 and L-SIG 412 are defined in the IEEE 802.11 standard for legacy compatibility. HE-SIG 416 is the high efficiency SIG field developed in accordance with IEEE 802.11ax, which can optionally be designed as two parts, HE-SIG1 and HE-SIG2. HE-STF 418 is a high efficiency STF field developed in accordance with IEEE 802.11ax, which can be the same, or different, for downlink and uplink. HE-LTF 422 is a high efficiency STF field developed in accordance with IEEE 802.11ax which, similar to HE-STF 418, may be the same or different for downlink and uplink. For HE-SIG 416, the same power level is applied across the band, but two different transmission power levels are applied for the OFDMA data parts (downlink data 426 in the OFDMA low power zone and uplink data 438 in the OFDMA low power zone and downlink data 442 in the OFDMA high power zone and uplink data 446 in the OFDMA high power zone). Similarly, two different transmission power levels are applied for the HE-STF (418/430) and HE-LTF (422/434). Exemplary usage of this scenario is discussed hereinafter in relation to FIG. 9.

FIG. 5 illustrates another exemplary transmission power control scheme which is directed toward a multi-power zone approach (1−N) rather than only two zones. The transmission power control scheme in FIG. 5 is similar to that in FIG. 4 with the main difference being instead of just having a high and low transmission power levels, multiple OFDMA zones for different power levels can provide more flexibility at the cost of requiring more overhead in the HE-SIG 416 field to signal the necessary information, such as the power level setting information. As shown in FIG. 5, there are multiple transmit power zones ranging from zone #1 501 through zone #N 503. As discussed, the HE-SIG field 416 includes information necessary to identify one or more of the power level and zone information that is being utilized for the remaining portion of the frame. Each power zone includes HE-STF, HE-LTF, DL data, and UL data portions.

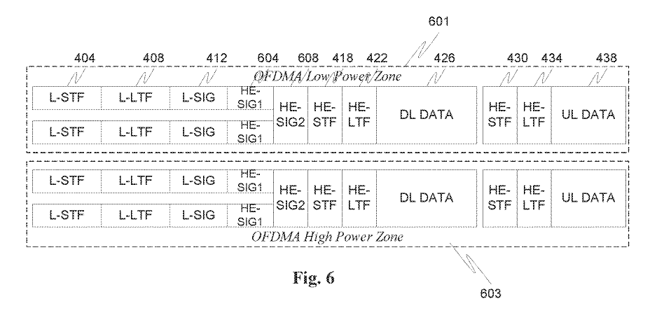

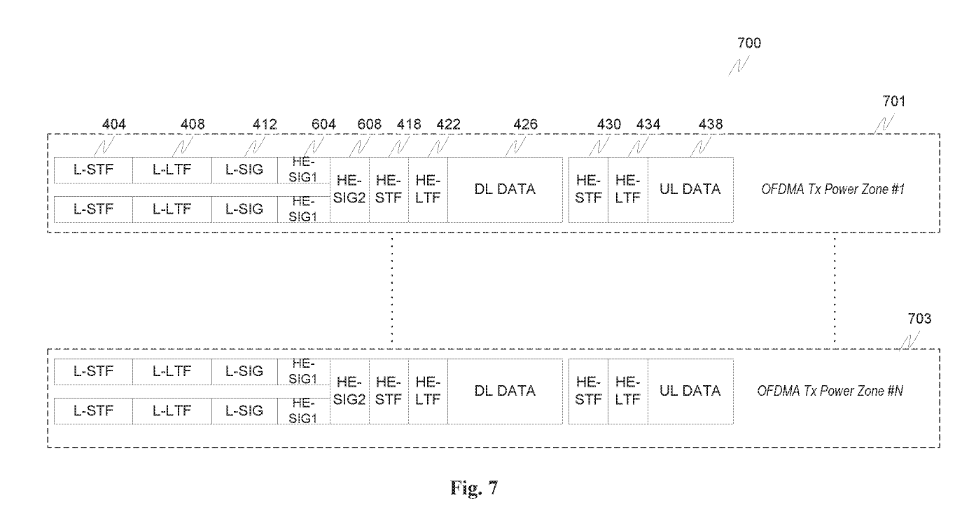

FIG. 6 illustrates a third exemplary transmission power control scheme where the power control levels can be applied to both control portions of the frame as well as data the data portions, such that, for example, the whole subband/zone is subject to transmission power control. Compared to the exemplary data-only transmission power control schemes as illustrated in FIGS. 4 and 5, the exemplary transmission power control scheme as illustrated in FIG. 6 does not require the HE-SIG field to carry the information for the transmission power level because the legacy preamble (L-STF, L-LTF and L-SIG) already provides the training information because of the exemplary frame format illustrated in FIG. 6.

In FIG. 6, there is an OFDMA low power zone 601 and an OFDMA high power zone 603. Each of these respective zones include L-STF 404, L-LTF 408, L-SIG 412, HE-SIG1 604, HE-SIG2 608, HE-STF 418, HE-LTF 422, download data 426, HE-STF 430, HE-LTF 434 and uplink data 438.

FIG. 7 illustrates an exemplary transmission power control scheme that is a combination of the exemplary power control scheme illustrated in FIG. 5 and the exemplary power control scheme illustrated in FIG. 6. As with FIG. 5, there are multiple transmission power control zones (illustratively shown as zone #1 701 through zone #N 703) with the exemplary scheme applying to both the control and the data portions of the frame 700. This multi-subband approach allows, for example, greater flexibility at the cost of higher complexity. As with the previous examples, there is an L-STF portion 404, L-LTF 408, L-SIG 412, HE-SIG1 604, HE-SIG2 608, HE-STF 418, HE-LTF 422, downlink data 426, HE-STF 430, HE-LTF 434 and uplink data 438.

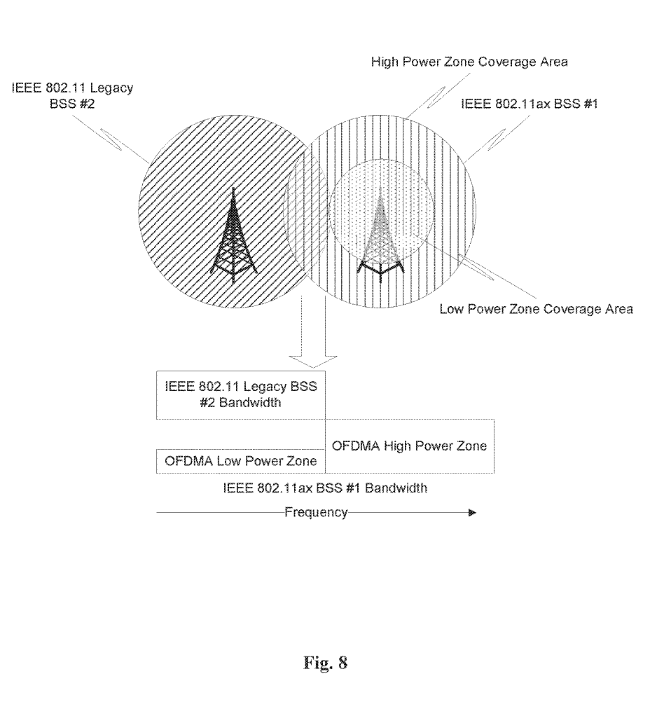

FIG. 8 illustrates an exemplary usage scenario where the problems presented in FIGS. 1 and 2 can be solved through the use of one or more of the exemplary interference mitigation techniques discussed herein. In FIG. 8, two OFDMA-based transmission power control zones are utilized, e.g., a high power zone and a low power zone. In FIG. 8, a legacy IEEE 802.11 device (legacy BSS #2) and an IEEE 802.11ax BSS in a mixed environment are shown.

Using the schemes illustrated in FIGS. 4 and 6, two different OFDMA based transmission power control zones are set up to provide the interference mitigation. In the example shown in FIG. 8, the OFDMA resource(s) in the low power OFDMA zone (or subband) would be assigned to the IEEE 802.11ax devices nearby the access point (or within a good range), and the OFDMA resource(s) in the high power OFDMA zones (or subbands) would be assigned to the IEEE 802.11ax devices at, for example, the cell edge of the access point. The performance for both the legacy as well as the IEEE 802.11ax access points could be improved due to the reduced interference afforded by the techniques discussed herein.

FIG. 9 illustrates another exemplary usage scenario where the exemplary frame structure illustrated in FIGS. 5 and 7 is used. This particular frame structure can be advantageous in, for example, large scale deployments, such as a typical cellular deployment as shown in FIG. 9. In FIG. 9, there are a plurality of different cells (#1, #2, #3) with corresponding configurations (Configuration #1, Configuration #2, Configuration #3). Each of the cells has a low power zone coverage area as illustrated in FIG. 9 with the area outside the low power zone coverage area being, for example, at the cell edge. In this exemplary usage scenario, three different OFDMA zones (or subbands) are set with three different power configurations (Configuration #1, Configuration #2, Configuration #3) by using two different power levels. As a result, a large scale deployment for many AP cells can be set/configured to realize an interference mitigation and improve the overall system performance, especially for cell edge users.

In Configuration #1, OFDMA zone #1 has a first power level while OFDMA zone #2 and zone #3 have a different power level(s). In Configuration #2, OFDMA zone #1 and OFDMA zone #3 are set as lower power zones, while OFDMA zone #2 is set as a higher powered zone. In Configuration #3, OFDMA zone #3 is set to be a higher powered zone than OFDMA zone #1 and OFDMA zone #2. As will be appreciated, while, for example, in configuration 1, zone #2 and zone #3 are illustrated as being at the same low-power level, they can be at respectively different low-power levels than OFDMA zone #1. This is similarly applicable to configuration #2 and configuration #3.

As with the other techniques discussed herein, this particular configuration results in a significant performance increase in large scale deployments due to the resultant interference mitigation.

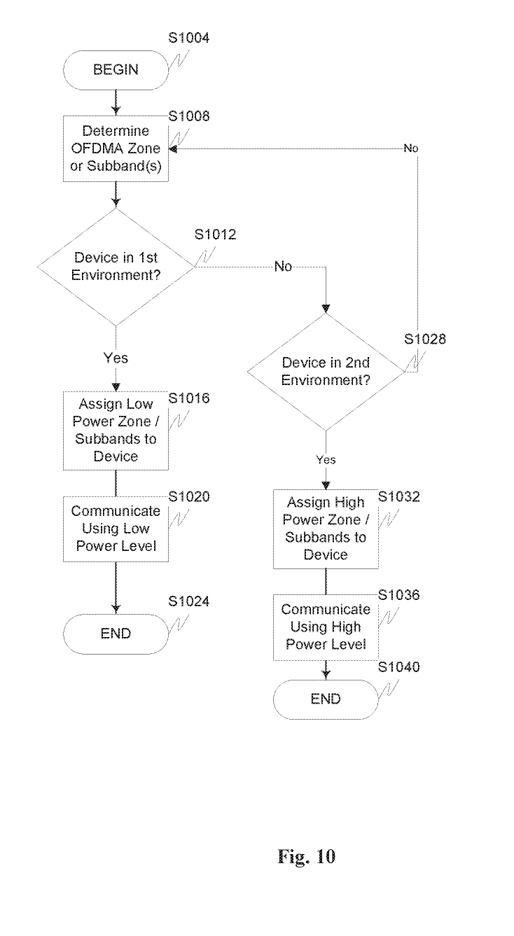

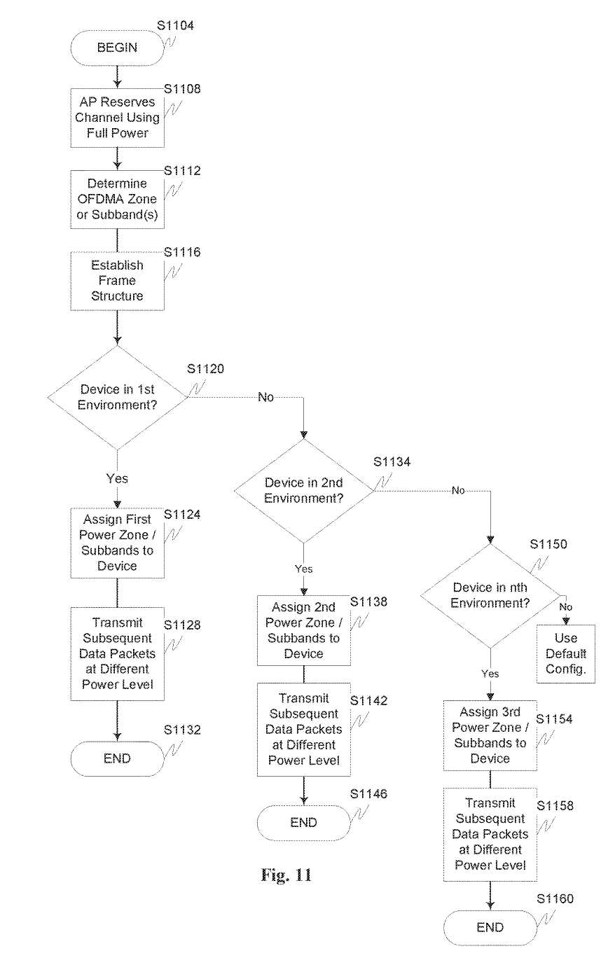

FIG. 10 outlines an exemplary method of assigning power zones/subbands. In particular, control begins in step S1004 and continues to step S1008. In step S1008 a determination is made as to how many power zones (or subbands) will be utilized. Next, in step S1012, a determination is made as to whether a device is in a first environment. If a device is in a first environment, control continues to step S1016 where the device is assigned a low power zone/subband. Control then continues to step S1020 where communication using the low power zone (or subband) occurs. Control then continues to step S1024 where the control sequence ends.

If it is determined that the device is not in the first environment, control continues to step S1024 where a determination is made as to whether the device is in a second environment. If the device is in the second environment, control continues to step S1028 with control otherwise jumping back to step S1008. In step S1028, the device is assigned a high power zone (or subband) with, in step S1032, the high power zone (or subband) used for communication. Control then continues to step S1036 communications using the high power level are used with control continuing to step S1040 where the control sequence ends.

FIG. 11 outlines another exemplary method for utilizing multiple different power zones (or subbands). Control begins in step S1104 and continues to step S1108. In step S1108, an access point reserves the channel using, for example, full power. Next, in step S1112, the number of OFDMA zones (or subbands) is determined. Then, in step S1116, an appropriate frame structure is established based on, for example, the determined number of OFDMA zones (or subbands). Control then continues to step S1120.

In step S1120, a determination is made as to whether a device is in a first environment. If a device is in a first environment, control continues to step S1124 with control otherwise continuing to step S1134.

In step S1124, the first power zone (or subband) is assigned to the device. Next, in step S1128, subsequent data packets are transmitted at a different power level than the configuration information. Control then continues to step S1132 where the control sequence ends.

In step S1134, a determination is made as to whether a device is in a second environment. If the device is in a second environment, control continues to step S1138 where the second power zone (or subband) is assigned to the device with, in step S1142, subsequent data packets are transmitted at a different power level than the configuration information. Control then continues to step S1146 where the control sequence ends.

In step S1150, a determination is made as to whether a device is in an n^{th} environment. If the device is in an n^{th} environment, control continues to step S1154 with control otherwise, for example, reverting to a default configuration. In step S1154, an n^{th} power zone is assigned with, in step S1158, subsequent data packets transmitted at a different power level than the configuration information. Control then continues to step S1160 where the control sequence ends.

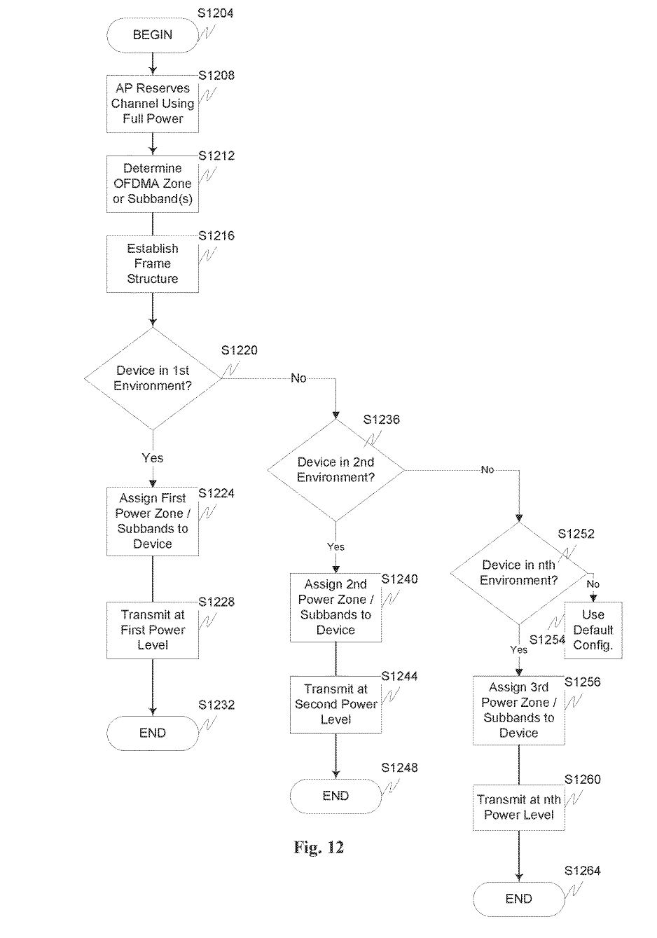

FIG. 12 illustrates another exemplary method for assigning power zones (or subbands). In particular, control begins in step S1204 and continues to step S1208. In step S1208, the access point optionally reserves a channel using full power. Next, in step S1212, the number of OFDMA zones (or subbands) is determined. Then, in step S1216, the frame structure to be used for transmission is established. Control then continues to step S1220.

In step S1220, a determination is made as to whether a device is in a first environment. If a device is in a first environment, control continues to step S1224 with control otherwise continuing to step S1236.

In step S1224, a first power zone (or subband) is assigned to a device. Next, in step S1228, a first power level is used for transmission with control continuing to step S1232 where the control sequence ends.

In step S1236, a determination is made as to whether a device is in a second environment. If a device is in a second environment, control continues to step S1240 with control otherwise continuing to step S1252. In step S1240, a second power zone (or subband) is assigned. Then, in step S1244, the second power level is used for transmission with control continuing to step S1248 where the control sequence ends.

In step S1252, a determination is made as to whether a device is in an n^{th} environment. If a device is within an n^{th} environment, control continues to step S1256 with control otherwise continuing to step S1254, where, for example, an optional default configuration can be used.

In step S1256, a third power zone (or subband) is assigned the device. Then, in step S1260, transmission at an n^{th} power level to the device commences. Control then continues to step S1264 where the control sequence ends.

It should be appreciated, the various power level schemes discussed herein can have their specific features interchanged with one or more of the other power level schemes to provide, for example, further interference mitigation for a specific environment. In addition, while all the techniques discussed herein have been specifically discussed in relation to IEEE 802.11ax and legacy systems, it should be appreciated that the techniques discussed herein can generally be applicable to any type of wireless communication standard, protocol, and/or equipment. Moreover, all the flowcharts have been discussed in relation to a set of exemplary steps, it should be appreciated that some of these steps could be optional and excluded from the operational flow without affecting the success of the technique. Additionally, steps provided in the various flowcharts illustrated herein can be used in other flowcharts illustrated herein.

In the following detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

Before undertaking the description of embodiments below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to power control in a wireless transceiver. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to 802.11 transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:
a processor;
a channel quality determination module configured to determine communication channel quality to one or more other wireless communications devices; and
a zone module configured to assign a zone/subband and corresponding power level to the one or more other wireless communications devices based on the communication channel quality.

Any one or more of the above aspects further comprising a power level controller configured to determine the corresponding power level.

Any one or more of the above aspects wherein there are a plurality of zones/subbands including a high power zone/subband and a low power zone/subband.

Any one or more of the above aspects wherein a first portion of a frame is transmitted at a high power level.

Any one or more of the above aspects wherein a second portion of a frame is transmitted at a high power level or a low power level.

Any one or more of the above aspects wherein a data portion of a frame is transmitted at a high power level.

Any one or more of the above aspects wherein a data portion of frame is transmitted at a high power level or a low power level.

Any one or more of the above aspects wherein there is a corresponding power level for each of a plurality of zones/subbands, the corresponding power level determined based on one or more of signal-to-noise ratio and channel quality index.

Any one or more of the above aspects wherein:
L-STF, L-LTF, L-SIG are transmitted at a first power level and HE-STF, HE-LTF, downlink data and uplink data are transmitted at a second power level, or
L-STF, L-LTF, L-SIG are transmitted at a first power level and HE-STF, HE-LTF, downlink data and uplink data are transmitted at the first second power level, or
   L-STF, L-LTF, L-SIG are transmitted at a first power level and HE-STF, HE-LTF, downlink data and uplink data are transmitted at the first second power level, and a second L-STF, a second L-LTF, a second L-SIG are transmitted at the second power level and HE-STF, HE-LTF, downlink data and uplink data are transmitted at the second power level.

Any one or more of the above aspects wherein the wireless communications device is an IEEE 802.11ax device, and a high power zone/subband is assigned to a high power zone coverage area and a low power zone/subband is assigned to a low power zone coverage area.

A method comprising:

determining communication channel quality from a first wireless communications device to one or more other wireless communications devices; and

assigning a zone/subband and corresponding power level to the one or more other wireless communications devices based on the communication channel quality.

Any one or more of the above aspects further comprising determining the corresponding power level.

Any one or more of the above aspects wherein there are a plurality of zones/subbands including a high power zone/subband and a low power zone/subband.

Any one or more of the above aspects wherein a first portion of a frame is transmitted at a high power level.

Any one or more of the above aspects wherein a second portion of a frame is transmitted at a high power level or a low power level.

Any one or more of the above aspects wherein a data portion of a frame is transmitted at a high power level.

Any one or more of the above aspects wherein a data portion of frame is transmitted at a high power level or a low power level.

Any one or more of the above aspects wherein there is a corresponding power level for each of a plurality of zones/subbands, the corresponding power level determined based on one or more of signal-to-noise ratio and channel quality index.

Any one or more of the above aspects wherein:
L-STF, L-LTF, L-SIG are transmitted at a first power level and HE-STF, HE-LTF, downlink data and uplink data are transmitted at a second power level, or
L-STF, L-LTF, L-SIG are transmitted at a first power level and HE-STF, HE-LTF, downlink data and uplink data are transmitted at the first second power level, or
   L-STF, L-LTF, L-SIG are transmitted at a first power level and HE-STF, HE-LTF, downlink data and uplink data are transmitted at the first second power level, and a second L-STF, a second L-LTF, a second L-SIG are transmitted at the second power level and HE-STF, HE-LTF, downlink data and uplink data are transmitted at the second power level.

Any one or more of the above aspects wherein the wireless communications device is an IEEE 802.11ax device, and a high power zone/subband is assigned to a high power zone coverage area and a low power zone/subband is assigned to a low power zone coverage area.

A system comprising:

means for determining communication channel quality from a first wireless communications device to one or more other wireless communications devices; and

means for assigning a zone/subband and corresponding power level to the one or more other wireless communications devices based on the communication channel quality.

Any one or more of the above aspects further comprising means for, further comprising determining the corresponding power level.

Any one or more of the above aspects wherein there are a plurality of zones/subbands including a high power zone/subband and a low power zone/subband.

Any one or more of the above aspects wherein a first portion of a frame is transmitted at a high power level.

Any one or more of the above aspects wherein a second portion of a frame is transmitted at a high power level or a low power level.

A non-transitory computer-readable information storage media, having stored thereon instructions, that when executed perform a method comprising:

determining communication channel quality from a first wireless communications device to one or more other wireless communications devices; and

assigning a zone/subband and corresponding power level to the one or more other wireless communications devices based on the communication channel quality.

Any one or more of the above aspects further comprising determining the corresponding power level.

Any one or more of the above aspects wherein there are a plurality of zones/subbands including a high power zone/subband and a low power zone/subband.

Any one or more of the above aspects wherein a first portion of a frame is transmitted at a high power level.

Any one or more of the above aspects wherein a second portion of a frame is transmitted at a high power level or a low power level.

Any one or more of the above aspects wherein a data portion of a frame is transmitted at a high power level.

Any one or more of the above aspects wherein a data portion of frame is transmitted at a high power level or a low power level.

Any one or more of the above aspects wherein there is a corresponding power level for each of a plurality of zones/subbands, the corresponding power level determined based on one or more of signal-to-noise ratio and channel quality index.

Any one or more of the above aspects wherein:
L-STF, L-LTF, L-SIG are transmitted at a first power level and HE-STF, HE-LTF, downlink data and uplink data are transmitted at a second power level, or
L-STF, L-LTF, L-SIG are transmitted at a first power level and HE-STF, HE-LTF, downlink data and uplink data are transmitted at the first second power level, or
   L-STF, L-LTF, L-SIG are transmitted at a first power level and HE-STF, HE-LTF, downlink data and uplink data are transmitted at the first second power level, and a second L-STF, a second L-LTF, a second L-SIG are transmitted at the second power level and HE-STF, HE-LTF, downlink data and uplink data are transmitted at the second power level.

Any one or more of the above aspects wherein the wireless communications device is an IEEE 802.11ax device, and a high power zone/subband is assigned to a high power zone coverage area and a low power zone/subband is assigned to a low power zone coverage area.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an 802.11 transceiver, or the like. Examples of wireless protocols that can be used with this technology include 802.11a, 802.11b, 802.11g, 802.11n, 802.11ac, 802.11ad, 802.11af, 802.11ah, 802.11ai, 802.11aj, 802.11aq, 802.11ax, WiFi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA™ or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has been provided systems and methods for power level control to improve, for example, interference mitigation. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a processor;
a channel quality determination module cooperating with the processor and configured to determine communication channel quality to one or more other wireless communications devices; and
a zone module configured to assign a zone/subband and corresponding power level to the one or more other wireless communications devices based on the communication channel quality.

2. The device of claim 1, further comprising a power level controller configured to determine the corresponding power level.

3. The device of claim 1, wherein there are a plurality of zones/subbands including a high power zone/subband and a low power zone/subband.

4. The device of claim 3, wherein a first portion of a frame is transmitted at a high power level.

5. The device of claim 3, wherein a second portion of a frame is transmitted at a high power level or a low power level.

6. The device of claim 3, wherein a data portion of a frame is transmitted at a high power level.

7. The device of claim 3, wherein a data portion of frame is transmitted at a high power level or a low power level.

8. The device of claim 1, wherein there is a corresponding power level for each of a plurality of zones/subbands, the corresponding power level determined based on one or more of signal-to-noise ratio and channel quality index.

9. The device of claim 1, wherein:
L-STF, L-LTF, L-SIG are transmitted at a first power level and HE-STF, HE-LTF, downlink data and uplink data are transmitted at a second power level, or
L-STF, L-LTF, L-SIG are transmitted at a first power level and HE-STF, HE-LTF, downlink data and uplink data are transmitted at the first second power level, or
L-STF, L-LTF, L-SIG are transmitted at a first power level and HE-STF, HE-LTF, downlink data and uplink data are transmitted at the first second power level, and a second L-STF, a second L-LTF, a second L-SIG are transmitted at the second power level and HE-STF, HE-LTF, downlink data and uplink data are transmitted at the second power level.

10. The device of claim 1, wherein the wireless communications device is an IEEE 802.11ax device, and a high power zone/subband is assigned to a high power zone coverage area and a low power zone/subband is assigned to a low power zone coverage area.

11. A method comprising:
determining communication channel quality from a first wireless communications device to one or more other wireless communications devices; and
assigning a zone/subband and corresponding power level to the one or more other wireless communications devices based on the communication channel quality.

12. The method of claim 11, further comprising determining the corresponding power level.

13. The method of claim 11, wherein there are a plurality of zones/subbands including a high power zone/subband and a low power zone/subband.

14. The method of claim 13, wherein a first portion of a frame is transmitted at a high power level.

15. The method of claim 13, wherein a second portion of a frame is transmitted at a high power level or a low power level.

16. The method of claim 13, wherein a data portion of a frame is transmitted at a high power level.

17. The method of claim 13, wherein a data portion of frame is transmitted at a high power level or a low power level.

18. The method of claim 11, wherein there is a corresponding power level for each of a plurality of zones/subbands, the corresponding power level determined based on one or more of signal-to-noise ratio and channel quality index.

19. The method of claim 11, wherein:
L-STF, L-LTF, L-SIG are transmitted at a first power level and HE-STF, HE-LTF, downlink data and uplink data are transmitted at a second power level, or
L-STF, L-LTF, L-SIG are transmitted at a first power level and HE-STF, HE-LTF, downlink data and uplink data are transmitted at the first second power level, or
L-STF, L-LTF, L-SIG are transmitted at a first power level and HE-STF, HE-LTF, downlink data and uplink data are transmitted at the first second power level, and a second L-STF, a second L-LTF, a second L-SIG are transmitted at the second power level and HE-STF, HE-LTF, downlink data and uplink data are transmitted at the second power level.

20. The method of claim 11, wherein the wireless communications device is an IEEE 802.11ax device, and a high power zone/subband is assigned to a high power zone coverage area and a low power zone/subband is assigned to a low power zone coverage area.

21. A system comprising:
means for determining communication channel quality from a first wireless communications device to one or more other wireless communications devices; and
means for assigning a zone/subband and corresponding power level to the one or more other wireless communications devices based on the communication channel quality.

22. The system of claim 21, further comprising means for, further comprising determining the corresponding power level.

23. The system of claim 21, wherein there are a plurality of zones/subbands including a high power zone/subband and a low power zone/subband.

24. The system of claim 23, wherein a first portion of a frame is transmitted at a high power level and a second portion of a frame is transmitted at a high power level or a low power level.

25. A non-transitory computer-readable information storage media, having stored thereon instructions, that when executed perform comprising:
determining communication channel quality from a first wireless communications device to one or more other wireless communications devices; and
assigning a zone/subband and corresponding power level to the one or more other wireless communications devices based on the communication channel quality.
